(19) United States
(12) Patent Application Publication
(10) Pub. No.: US 2024/0380278 A1
(43) Pub. Date: Nov. 14, 2024

(54) ESP GENERATOR

(71) Applicant: SCHLUMBERGER TECHNOLOGY CORPORATION, Sugar Land, TX (US)

(72) Inventors: Andrey FASTOVETS, Houston, TX (US); Stephen DYER, Houston, TX (US); Benoit DEVILLE, Houston, TX (US); David Milton ESLINGER, Bartlesville, OK (US); Maksim RADOV, Singapore (SG); Janet SAVARIMUTHU, Garden Grove, CA (US)

(21) Appl. No.: 18/686,049

(22) PCT Filed: Sep. 30, 2022
(86) PCT No.: PCT/US2022/045390

§ 371 Date: Feb. 23, 2024

Related U.S. Application Data
(60) Provisional application No. 63/261,967, filed on Oct. 1, 2021.
(60) Provisional application No. 63/262,064, filed on Oct. 4, 2021.

(51) Int. Cl. H02K 7/18; E21B 41/00; E21B 43/12; F03B 13/10

(52) U.S. Cl. CPC H02K 7/183; E21B 41/0064; E21B 43/128; F03B 13/10

(57) ABSTRACT

Systems and methods for power recovery in carbon capture and storage applications are provided. Such systems and methods include ESP systems including permanent magnet motors (PMM) or induction motors (IM). Systems and methods for power generation including permanent magnet motor electric submersible pumps are also provided.

### CROSS-REFERENCE TO RELATED APPLICATIONS

The present application claims priority benefit of U.S. Provisional Application Nos. 63/261,967, filed Oct. 1, 2021, and 63/262,064, filed Oct. 4, 2021, the entirety of each of which is incorporated by reference herein and should be considered part of this specification.

### BACKGROUND

### Field

The present disclosure generally relates to electric submersible pump (ESP) generators, more particularly permanent magnet motor ESP generators, and carbon capture and storage, more particularly power recovery in carbon capture and storage applications using a downhole multistage electric submersible pump (ESP) system.

### Description of the Related Art

Various types of artificial lift equipment and methods are available, for example, electric submersible pumps (ESPs). An ESP includes multiple centrifugal pump stages mounted in series, each stage including a rotating impeller and a stationary diffuser mounted on a shaft, which is coupled to a motor. In use, the impellers rotate within the diffusers.

Carbon capture and storage processes capture CO₂ emissions from various sources, such as the atmosphere and power generation or industrial facilities that use fossil fuels. The captured carbon dioxide can be stored onsite, or transported for storage or use at remote locations.

### SUMMARY

In some configurations, a power generation system includes an electric submersible pump including a pump configured to act as a turbine and a permanent magnet motor configured to act as a generator.

The electric submersible pump can be configured to selectively operate in a pumping mode and in a generation mode. In the generation mode, the pump acts as the turbine and the motor acts as the generator.

In some configurations, a power generation method includes deploying an electric submersible pump in a well, the electric submersible pump comprising a pump configured to act as a turbine and a permanent magnet motor configured to act as a generator; injecting fluid from the surface through the pump; and using the motor, harvesting energy from the fluid passing through the pump.

In some configurations, a carbon capture and storage system includes an electric submersible pump including a pump configured to act as a turbine and a motor configured to act as a generator.

The system can include a VSD at a surface location. The system can include a cable extending from the VSD to the motor, the cable configured to carry energy harvested by the electric submersible pump from the motor to the surface. The VSD can be configured to maximize thermal preheating of the injected CO₂ while adjusting for the pressure drop through the pump.

In some configurations, a carbon capture and storage method can include deploying an electric submersible pump in a well, the electric submersible pump comprising a pump configured to act as a turbine and a motor configured to act as a generator; injecting CO₂ from the surface through the pump; and using the motor, harvesting energy from a pressure drop of the CO₂ passing through the pump.

The method can include preheating the CO₂ prior to passing the through the pump. The method can include injecting the CO₂ into a subsurface formation for storage. The method can include sending the harvested energy to a power grid. The method can include using the harvested power to offset power draw from CO₂ injection pumps used to inject the CO₂ from the surface through the pump. The method can include controlling flow and pressure drop through the pump via a regen-capable variable speed drive (VSD).

In some configurations, a method of operating an electric submersible pump comprising a pump and motor includes: selecting a mode of operation of the electric submersible pump from a pumping mode and a generation mode, the pumping mode configured to pump fluid from a reservoir to a surface location and the generation mode configured to harvest energy from fluid injected from the surface location passing through the pump; and operating the electric submersible pump in the selected mode. The method can further include controlling flow and pressure drop through the pump via a regen-capable variable speed drive (VSD).

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1A shows an ESP in pumping mode operation.

FIG. 1B shows an ESP in generation mode operation, for example, in a CCS injection system.

FIG. 2 shows a schematic of an electric submersible pump (ESP) system.

FIG. 3 shows a longitudinal cross-section of a portion of a pump of the ESP system of FIG. 2.

FIG. 4 shows components of an induction motor and a permanent magnet motor for an ESP.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

Carbon capture and storage (CCS) processes capture CO₂ emissions from various sources, such as the atmosphere and power generation or industrial facilities that use fossil fuels. The captured carbon dioxide can be stored onsite, or transported for storage or use at remote locations. In some configurations, the captured CO₂ is injected into subsurface geological formations, such as depleted oil and gas reservoirs, for storage.

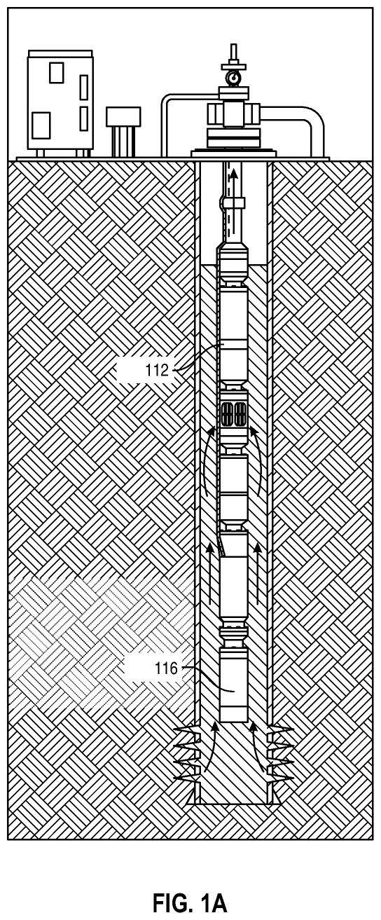

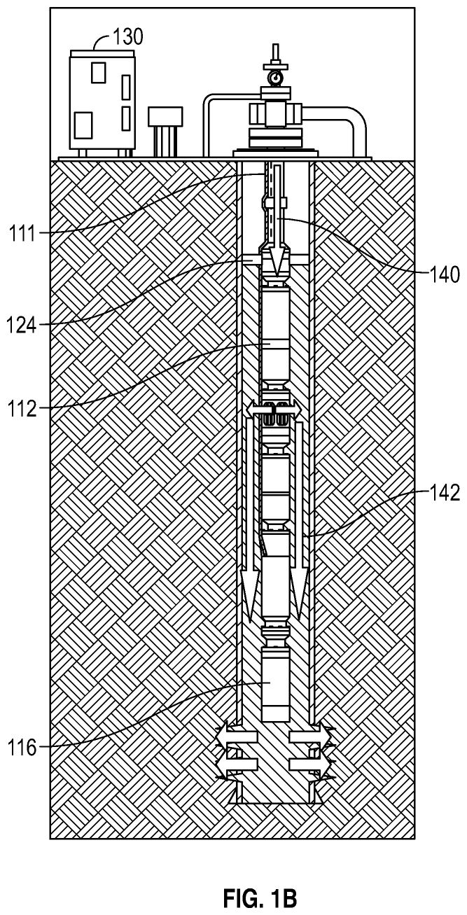

Some CCS systems include a downhole flow control valve (FCV). The FCV can be used to regulate the flow of a CO₂ stream during injection into a subsurface formation for storage. The frictional pressure drop across the FCV represents energy lost or dissipated. In some systems and methods according to the present disclosure, the FCV can be replaced by an ESP system including a pump and motor properly sized for the pressure differential and desired flowrate, for example as shown in FIG. 1B.

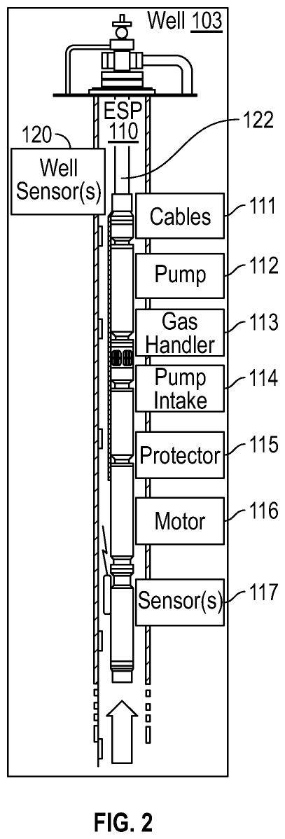

As shown in FIG. 2, an electric submersible pump (ESP) 110 typically includes a motor 116, a protector 115, a pump 112, a pump intake 114, and one or more cables 111, which can include an electric power cable. The motor 116 can be powered and controlled by a surface power supply and controller, respectively, via the cables 111. The motor 116 can be a permanent magnet motor (PMM) or an induction motor (IM). In some configurations, the ESP 110 also includes gas handling features 113 and/or one or more sensors 117 (e.g., for temperature, pressure, current leakage, vibration, etc.). As shown, the well may include one or more well sensors 120. The ESP 110 can be coupled to or along well tubing 122. An isolation packer 124 can be disposed along the tubing 112, for example as shown in FIG. 1.

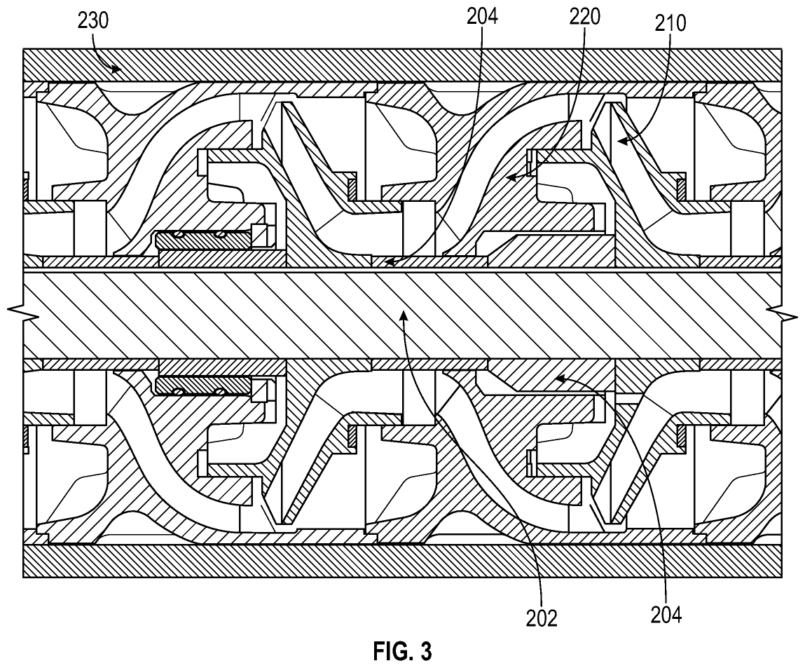

The pump 112 includes multiple centrifugal pump stages mounted in series within a housing 230, as shown in FIG. 3. Each stage includes a rotating impeller 210 and a stationary diffuser 220. One or more spacers 204 can be disposed axially between sequential impellers 210. A shaft 202 extends through the pump 112 (e.g., through central hubs or bores or the impellers 210 and diffusers 220) and is operatively coupled to the motor 116. The shaft 202 can be coupled to the protector 115 (e.g., a shaft of the protector), which in turn can be coupled to the motor 116 (e.g., a shaft of the motor). The impellers 210 are rotationally coupled, e.g., keyed, to the shaft 202. The diffusers 220 are coupled, e.g., rotationally fixed, to the housing 230. In use, the shaft 202 and the impellers 210 rotate relative to and within the stationary diffusers 220.

In typical ESP pumping mode operation, for example as shown in FIG. 1A, the motor 116 causes rotation of the shaft 202 (for example, by rotating the protector 115 shaft, which rotates the pump shaft 202), which in turn rotates the impellers 210 relative to and within the stationary diffusers 220. Well fluid flows into the first (lowest) stage of the ESP 110 and passes through an impeller 210, which centrifuges the fluid radially outward such that the fluid gains energy in the form of velocity. Upon exiting the impeller 210, the fluid makes a sharp turn to enter a diffuser 220, where the fluid's velocity is converted to pressure. The fluid then enters the next impeller 210 and diffuser 220 stage to repeat the process. As the fluid passes through the pump stages, the fluid incrementally gains pressure until the fluid has sufficient energy to travel to the well surface.

The present application provides systems and methods for power generation using an ESP. Such systems and methods include ESP systems including permanent magnet motors (PMM). In some configurations, a PMM can enable higher efficiency, compared to induction motors (IM), across a wider range of turbine operation modes (e.g., in both pumping and generation modes) due to permanent magnetic flux created by strong rare earth magnets installed in the PMM rotor. A PMM generator does not require external excitation and can produce higher energy output across a wider range of turbine operating conditions.

In systems and methods according to the present disclosure, an ESP can be operated as a turbine driven generator to recuperate energy, as shown in FIG. 1B. In other words, the pump 112 acts as a turbine, and the motor 116 acts as a generator. The pump or turbine 112 can be built for single-phase, multiphase, or gas, and can be designed to operate at speeds of up to 10,000 rpm and above. The harvested power can be sent to the grid and used for grid balancing (pumped storage). In generation mode in use, fluid 140 from the surface is injected through the multistage pump 112 operating as a turbine (in the opposite direction of fluid flow through the pump 112 in pumping mode), which spins the PMM 116 operating as an efficient generator. Such systems and methods allow for injection into depleted wells with low pressure and high injectivity. Generation can be continuous or intermittent (e.g., grid balancing) to support wind and solar operations. A regen-capable variable speed drive (VSD) 130, for example at the surface, can provide electrical control for the system.

In some configurations, an ESP system or method according to the present disclosure can operate in pumping mode (e.g., as shown in FIG. 1A) to produce fluid from deeper downhole in the reservoir to the surface more efficiency to then be stored in surface tanks or another storage facility, or operate in generation mode (e.g., as shown in FIG. 1B). Systems and methods according to the present disclosure can advantageously provide energy savings, minimized downtime, optimized cost and space, and/or maximized motor performance and efficiency.

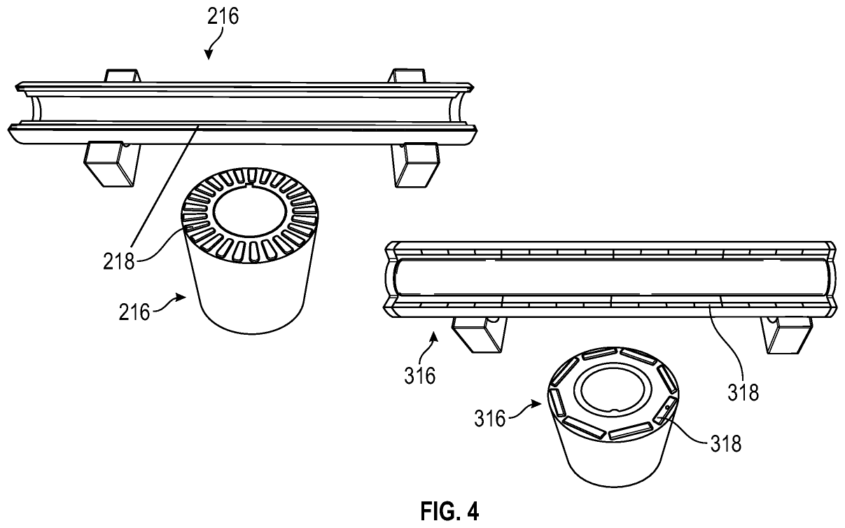

The present application also provides systems and methods for power recovery in CCS applications. Such systems and methods include ESP systems. The ESP motor 116 can be a permanent magnet motor (PMM) or induction motor (IM), for example as shown in FIG. 4. As shown, a rotor 216 of an induction motor includes axially extending copper rods 218. A rotor 316 of a permanent magnet motor includes a plurality of permanent magnets 318, e.g., strong rare earth magnets. In some configurations, a PMM can enable higher efficiency across a wider range of turbine operation modes due to permanent magnetic flux created by the strong rare earth magnets 318 installed in the PMM rotor 316.

As shown in FIG. 1B, the ESP can be operated as a turbine driven generator to recuperate energy. In other words, the pump 112 acts as a turbine, and the motor 116 acts as a generator. The pump 112 or turbine can be built for single-phase, multiphase, or gas, and can be designed to operate at speeds of up to 10,000 rpm and above. In CCS applications, the fluid 140 injected through the pump 112 is CO₂. In use, a high pressure CO₂ stream 140 is injected into the turbine 112, for example via tubing 122. The CO₂ stream travels downhole through the pump 112, e.g., reverse from the direction of produced fluids in typical ESP operation. The CO₂ exits the pump 112 (e.g., via the pump 112 inlet as used in typical ESP operation) as a low pressure stream 142. The CO₂ can enter the formation for storage. As the CO₂ travels through the pump 112, the motor 116 generates power from the pressure drop through the pump 112. The harvested power can be sent to the grid. Alternatively, the harvested power can be used to offset power draw from CO₂ injection pumps, which can improve overall CCS process efficiency and reduce cost. The present application advantageously improves system efficiency and provides for simple and reliable flow control in CCS applications.

The ESP system can also enable variable control of flow and pressure drop through the pump (turbine) 112 via a regen-capable VSD 130 located at the surface and connected to the ESP motor (generator) 116 via a downhole cable 111, for example as shown in FIG. 1B. The effective control of the turbine 112 and motor (generator) 116 can be tuned to preheat the injected CO₂ (or other fluid) prior to passing through the turbine 112 stages. This can help mitigate Joule-Thomson related cooling through the turbine 112, which could cause sub-zero temperatures in or around the device. The VSD control system 130 can be optimized to maximize thermal heating while adjusting for the pressure drop through the turbine 112 stages. In some configurations, the system, e.g., a controller of the system, can be used to measure the effective downhole injection rate by using known energy criteria.

Systems and methods of the present disclosure can therefore provide various benefits, including: customized and highly dynamic pressure regulation; a distributed pressure drop through the turbine 112 stages, thereby minimizing localized cooling which could affect material properties; generated power that can be used at the surface to offset the energy required to transport or inject the CO₂; injection rate measurements; and/or integrated control for the injection pump and downhole pressure regulation, and automation for start up and shut down procedures.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. A power generation system comprising:
an electric submersible pump comprising:
a pump configured to act as a turbine; and
a motor configured to act as a generator.

2. The system of claim 1, wherein the motor is a permanent magnet motor.

3. The system of claim 1, the electric submersible pump configured to selectively operate in a pumping mode and in a generation mode, wherein in the generation mode the pump acts as the turbine and the motor acts as the generator.

4. A carbon capture and storage system comprising the system of claim 1, wherein in use, the pump is configured to receive injected CO₂, and the motor is configured to generate power from a pressure drop of the CO₂ passing through the pump.

5. The system of claim 4, further comprising a VSD located at a surface location.

6. The system of claim 5, further comprising a cable extending from the VSD to the motor, the cable configured to carry energy harvested by the electric submersible pump from the motor to the surface.

7. The system of claim 5, the VSD configured to maximize thermal preheating of the injected CO₂ while adjusting for the pressure drop through the pump.

8. A carbon capture and storage method comprising:
deploying an electric submersible pump in a well, the electric submersible pump comprising:
a pump configured to act as a turbine; and
a motor configured to act as a generator;
injecting CO₂ from the surface through the pump; and
using the motor, harvesting energy from a pressure drop of the CO₂ passing through the pump.

9. The method of claim 8, further comprising preheating the CO₂ prior to passing the CO₂ through the pump.

10. The method of claim 8, further comprising injecting the CO₂ into a subsurface formation for storage.

11. The method of claim 8, further comprising sending the harvested energy to a power grid.

12. The method of claim 8, further comprising using the harvested power to offset power draw from CO₂ injection pumps used to inject the CO₂ from the surface through the pump.

13. The method of claim 8, further comprising controlling flow and pressure drop through the pump via a regen-capable variable speed drive (VSD).

14. A power generation method comprising:
deploying an electric submersible pump in a well, the electric submersible pump comprising:
a pump configured to act as a turbine; and
a permanent magnet motor configured to act as a generator;
injecting fluid from the surface through the pump; and
using the motor, harvesting energy from the fluid passing through the pump.

15. A method of operating an electric submersible pump, the electric submersible pump comprising a pump and a motor, the method comprising:
selecting a mode of operation of the electric submersible pump from a pumping mode and a generation mode, the pumping mode configured to pump fluid from a reservoir to a surface location and the generation mode configured to harvest energy from fluid injected from the surface location passing through the pump; and
operating the electric submersible pump in the selected mode.

16. The method of claim 15, further comprising controlling flow and pressure drop through the pump via a regen-capable variable speed drive (VSD).

17. The method of claim 15, wherein the motor is a permanent magnet motor.
